(19) United States
(12) Patent Application Publication
(10) Pub. No.: US 2024/0388383 A1
(43) Pub. Date: Nov. 21, 2024

(54) APPARATUS AND METHODS FOR RELIABILITY ADAPTATION FOR ARTIFICIAL INTELLIGENCE TRAINING

(71) Applicant: Huawei Technologies Co., Ltd., Shenzhen (CN)

(72) Inventors: Hao Tang, Ottawa (CA); Liqing Zhang, Ottawa (CA); Jianglei Ma, Ottawa (CA); Yiqun Ge, Kanata (CA); Peiying Zhu, Kanata (CA); Wen Tong, Ottawa (CA)

(21) Appl. No.: 18/785,872

(22) Filed: Jul. 26, 2024

Related U.S. Application Data
(63) Continuation of application No. PCT/CN2022/074159, filed on Jan. 27, 2022.

(51) Int. Cl. H04L 1/1812; H04L 1/1829

(52) U.S. Cl. CPC H04L 1/1819; H04L 1/1864

(57) ABSTRACT

Current online training procedures for artificial intelligence/machine learning (AI/ML) models for wireless communication generally suffer from high communication overhead and/or significant delays in training, particularly when training data is exchanged over an unreliable/hostile communication channel. An example method includes communicating, in accordance with a first communication mode, data or control information with a second device in the wireless communication network. The first communication mode is one of a plurality of communication modes comprising at least the first communication mode and a second communication mode, the second communication mode differing from the first communication mode in terms of at least one of a quantization level used to quantize values of variables in the data or control information, or a Hybrid Automatic Repeat reQuest (HARQ) feedback and retransmission mode for selective retransmission of one or more portions of the data or control information.

### CROSS-REFERENCE TO RELATED APPLICATIONS

This application is a continuation of International Application No. PCT/CN2022/074159, filed on Jan. 27, 2022, which is hereby incorporated by reference in its entirety.

### TECHNICAL FIELD

The present disclosure relates to wireless communication generally, and, in particular embodiments, to methods and apparatuses for reliability adaptation for artificial intelligence training.

### BACKGROUND

Artificial Intelligence technologies may be applied in communication, including AI-based communication in the physical layer and/or AI-based communication in the medium access control (MAC) layer. For example, in the physical layer, the AI-based communication may aim to optimize component design and/or improve the algorithm performance. For the MAC layer, the AI-based communication may aim to utilize the AI capability for learning, prediction, and/or making a decision to solve a complicated optimization problem with possible better strategy and/or optimal solution, e.g. to optimize the functionality in the MAC layer.

In some embodiments, an AI architecture in a wireless communication network may involve multiple nodes, where the multiple nodes may possibly be organized in one of two modes, i.e., centralized and distributed, both of which may be deployed in an access network, a core network, or an edge computing system or third party network. A centralized training and computing architecture is restricted by possibly large communication overhead and strict user data privacy. A distributed training and computing architecture may comprise several frameworks, e.g., distributed machine learning and federated learning.

However, communications in wireless communications systems, including communications associated with AI training at multiple nodes, typically occur over non-ideal channels. For example, non-ideal conditions such as electromagnetic interference, signal degradation, phase delays, fading, and other non-idealities may attenuate and/or distort a communication signal or may otherwise interfere with or degrade the communications capabilities of the system.

Conventional AI training processes generally rely on hybrid automatic repeat request (HARQ) feedback and retransmission processes to try to ensure that data communicated between devices involved in AI training is successfully received. However, the communication overhead and delay associated with such retransmissions can be problematic.

For these and other reasons, new protocols and signaling mechanisms are desired so that new AI-enabled applications and processes can be implemented while minimizing signaling and communication overhead and delays associated with existing AI training procedures.

### SUMMARY

According to a first broad aspect of the present disclosure, there is provided herein a method in a first device for communicating data or control information for artificial intelligence or machine learning (AI/ML) model training in a wireless communication network. The method may include, at the first device, communicating, in accordance with a first communication mode, data or control information with a second device in the wireless communication network. The first communication mode may be one of a plurality of communication modes that includes at least the first communication mode and a second communication mode. The second communication mode may differ from the first communication mode in one or more ways. For example, the second communication mode may differ from the first communication mode in terms of: a quantization level used to quantize values of variables in the data or control information; and/or a Hybrid Automatic Repeat reQuest (HARQ) feedback and retransmission mode for selective retransmission of one or more portions of the data or control information.

Supporting multiple communication modes provides a tradeoff between overhead reductions and training performance. For example, avoiding retransmissions and/or utilizing lower precision quantization in the first communication mode can reduce communication overhead during an early phase of training. However, once the outcome of training fails to meaningfully improve in the first communication mode, the communicating devices can be switched to operate in a second communication mode in order to further improve the training performance.

In some embodiments, transmission of the data or control information that is communicated with the second device is scheduled by downlink control information DCI. For example, a cyclic redundancy check (CRC) value of the DCI may be scrambled with a first radio network temporary identifier (RNTI) that is different from a Cell RNTI (C-RNTI). For example, the first RNTI may be an RNTI used specifically for AI/ML training related communications in the wireless communication network.

In some embodiments, the method may further include training an AI/ML model at the first device based on the data or control information communicated with the second device. For example, the first device may receive data or control information from the second device and train an AI/ML model based on the data or control information received from the second device.

In some embodiments, a first HARQ feedback and retransmission mode is used in the first communication mode and a second HARQ feedback and retransmission mode is used in the second communication mode. For example, there may be no HARQ feedback process and no retransmission of the data or control information between the first device and the second device in the first HARQ feedback and retransmission mode. However, in the second HARQ feedback and retransmission mode, a HARQ feedback process may be used to request retransmission of one or more portions of the data or control information. In other embodiments, both the first HARQ feedback and retransmission mode and the second HARQ feedback and retransmission mode may support a HARQ feedback process. For example, in some embodiments, N1 retransmissions may be permitted in the first HARQ feedback and retransmission mode, wherein N1 is an integer and N1≥1, and a maximum of N2 retransmissions may be permitted in the second HARQ feedback and retransmission mode, wherein N2 is an integer and N2>N1.

In some embodiments, the first communication mode may be used by default during an initial portion of a data or control information communication procedure. The second communication mode may be used during a later portion of the data or control information communication procedure once one or more criteria for switching communication modes has been satisfied. For example, in some embodiments, the first device may switch from communicating data or control information with the second device in accordance with the first communication mode to communicating data or control information with the second device in accordance with the second communication mode after a predetermined or preconfigured AI/ML model training time has elapsed or after a number of AI/ML model training iterations have occurred. In addition or instead, before switching from the first communication mode to the second communication mode, the first device may transmit control signaling to the second device containing a switching instruction. In some embodiments, the control signaling containing a switching instruction may be a downlink control information (DCI) message. After transmitting the control signaling, the first device may then switch from the first communication mode to the second communication mode. In some embodiments, the first device may switch from the first communication mode to the second communication mode after receiving control signaling containing a switching instruction from the second device.

In some embodiments, after switching to the second communication mode, the first device may receive HARQ feedback information from the second device identifying one or more portions of data that was not successfully received by the second device. In such embodiments, the first device, after receiving the HARQ feedback information, may transmit HARQ process information identifying at least one of the one or more unsuccessfully received portions of the data that will not be retransmitted by the first device. Furthermore, after transmitting the HARQ process information, the first device may then retransmit a partial subset of the one or more unsuccessfully received portions, wherein the partial subset excludes the at least one unsuccessfully received portion identified in the HARQ process information. In some embodiments, for each portion of the data that was not successfully received by the second device, the first device may receive from the second device importance indicator information corresponding to the unsuccessfully received portion. For example, the importance indicator information corresponding to the unsuccessfully received portion may indicate whether the unsuccessfully received portion is important to AI/ML model training at the second device. The first device may then selectively retransmit the partial subset of the one or more unsuccessfully received portions based on the importance indicator information from the second device.

In some embodiments, the method may further include transmitting, from the first device to the second device, control signaling containing a stop training instruction to configure the second device to stop training of an AI/ML model at the second device. If a device is not able to meaningfully contribute to a training procedure, being able to dynamically instruct the device to stop training may have several benefits. For example, stopping a non-contributing device from participating in training may reduce air interface overhead and/or training convergence may be achieved faster. In some embodiments, the control signaling containing a stop training instruction may be a DCI message. In some embodiments, the first device may stop transmitting data or control information for AI/ML model training to the second device after receiving control signaling containing a stop training instruction from the second device.

In some embodiments, the first device may transmit assistance information to the second device. For example, the assistance information may contain a training stop request from the first device to stop training of the AI/ML model at the first device.

In some embodiments, after switching to the second communication mode, the first device may transmit HARQ feedback information to the second device to inform the second device that data was not successfully received by the first device. In some embodiments, in addition to the HARQ feedback information, the first device may also transmit importance indicator information corresponding to the unsuccessfully received data. For example, the importance indicator information corresponding to the unsuccessfully received data may indicate whether the unsuccessfully received data is important to AI/ML model training at the first device.

Corresponding apparatuses and devices are disclosed for performing the methods.

For example, according to another aspect of the disclosure, a device is provided that includes a processor and a memory storing processor-executable instructions that, when executed, cause the processor to carry out a method according to the first broad aspect of the present disclosure described above.

According to other aspects of the disclosure, an apparatus including one or more units for implementing any of the method aspects as disclosed in this disclosure is provided. The term “units” is used in a broad sense and may be referred to by any of various names, including for example, modules, components, elements, means, etc. The units can be implemented using hardware, software, firmware or any combination thereof.

### BRIEF DESCRIPTION OF THE DRAWINGS

Reference will now be made, by way of example only, to the accompanying drawings which show example embodiments of the present application, and in which:

FIG. 1 is a simplified schematic illustration of a communication system, according to one example;

FIG. 2 illustrates another example of a communication system;

FIG. 3 illustrates an example of an electronic device (ED), a terrestrial transmit and receive point (T-TRP), and a non-terrestrial transmit and receive point (NT-TRP);

FIG. 4 illustrates example units or modules in a device;

FIG. 5 illustrates four EDs communicating with a network device in a communication system, according to one embodiment;

FIG. 6A illustrates and example of a neural network with multiple layers of neurons, according to one embodiment;

FIG. 6B illustrates an example of a neuron that may be used as a building block for a neural network, according to one embodiment;

FIGS. 7, 8, 9 and 10 illustrate methods performed by a first device and a second device, according to various embodiments.

Similar reference numerals may have been used in different figures to denote similar components.

### DETAILED DESCRIPTION

For illustrative purposes, specific example embodiments will now be explained in greater detail below in conjunction with the figures.

### Example Communication Systems and Devices

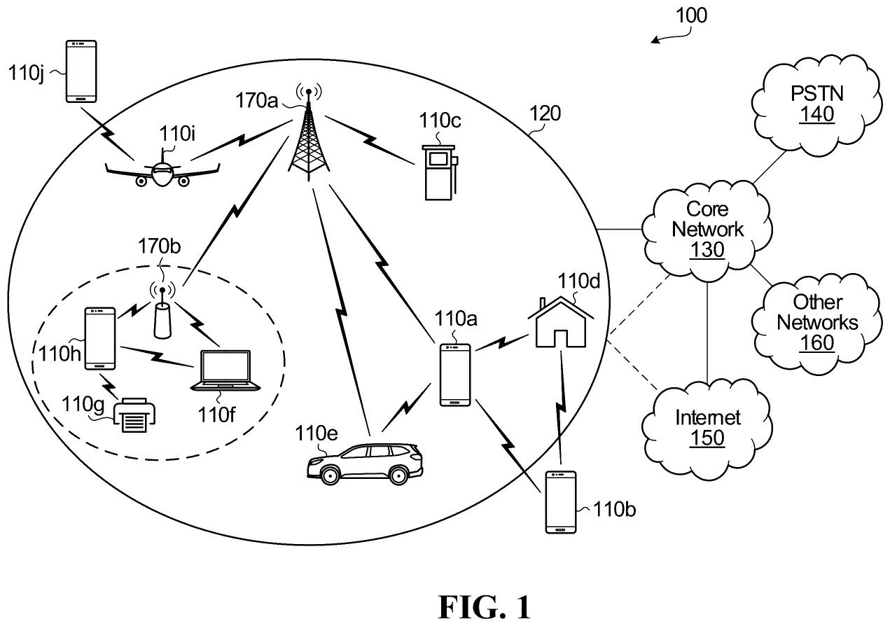

Referring to FIG. 1, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

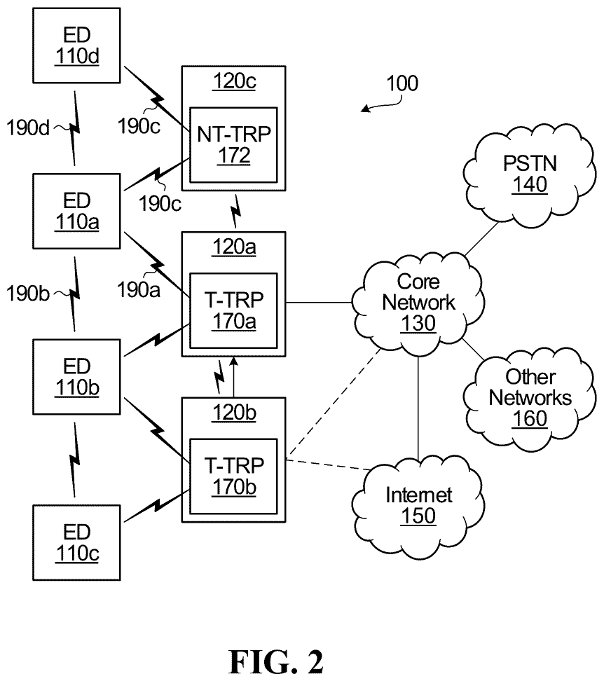

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies and incorporate multiple transceivers necessary to support such.

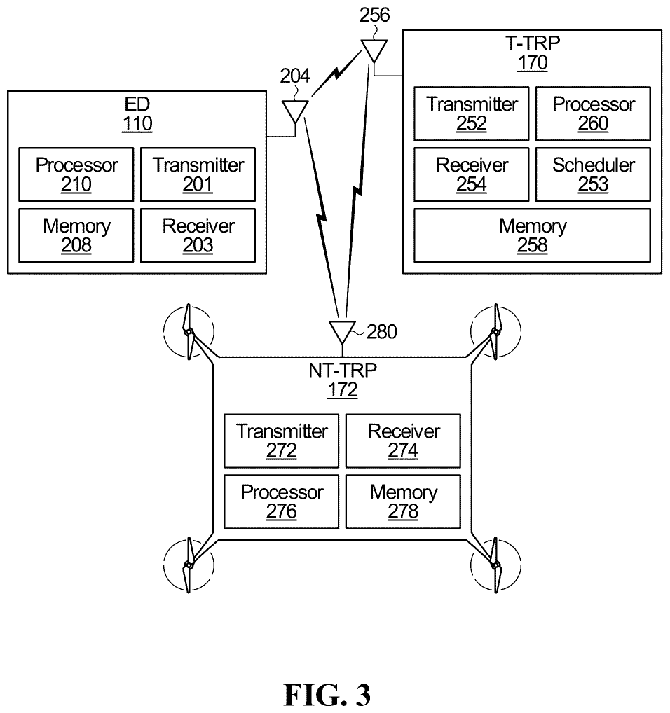

FIG. 3 illustrates another example of an ED no and a base station 170a, 170b and/or 170c. The ED no is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP)), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forging devices or apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

Note that “TRP”, as used herein, may refer to a T-TRP or a NT-TRP.

The T-TRP 170, the NT-TRP 172, and/or the ED 110 may include other components, but these have been omitted for the sake of clarity.

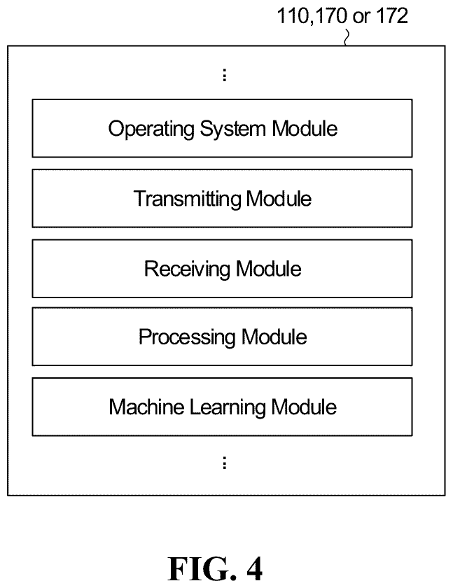

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

Control signaling is discussed herein in some embodiments. Control signaling may sometimes instead be referred to as signaling, or control information, or configuration information, or a configuration. In some cases, control signaling may be dynamically indicated, e.g. in the physical layer in a control channel. An example of control signaling that is dynamically indicated is information sent in physical layer control signaling, e.g. downlink control information (DCI). Control signaling may sometimes instead be semi-statically indicated, e.g. in RRC signaling or in a MAC control element (CE). A dynamic indication may be an indication in lower layer, e.g. physical layer/layer 1 signaling (e.g. in DCI), rather than in a higher-layer (e.g. rather than in RRC signaling or in a MAC CE). A semi-static indication may be an indication in semi-static signaling. Semi-static signaling, as used herein, may refer to signaling that is not dynamic, e.g. higher-layer signaling, RRC signaling, and/or a MAC CE. Dynamic signaling, as used herein, may refer to signaling that is dynamic, e.g. physical layer control signaling sent in the physical layer, such as DCI.

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g. data) over a wireless communications link. The wireless communications link may support a link between a radio access network and user equipment (e.g. a “Uu” link), and/or the wireless communications link may support a link between device and device, such as between two user equipments (e.g. a “sidelink”), and/or the wireless communications link may support a link between a non-terrestrial (NT)-communication network and user equipment (UE). The followings are some examples for the above components:
A waveform component may specify a shape and form of a signal being transmitted. Waveform options may include orthogonal multiple access waveforms and non-orthogonal multiple access waveforms. Non-limiting examples of such waveform options include Orthogonal Frequency Division Multiplexing (OFDM), Filtered OFDM (f-OFDM), Time windowing OFDM, Filter Bank Multicarrier (FBMC), Universal Filtered Multicarrier (UFMC), Generalized Frequency Division Multiplexing (GFDM), Wavelet Packet Modulation (WPM), Faster Than Nyquist (FTN) Waveform, and low Peak to Average Power Ratio Waveform (low PAPR WF).
A frame structure component may specify a configuration of a frame or group of frames. The frame structure component may indicate one or more of a time, frequency, pilot signature, code, or other parameter of the frame or group of frames. More details of frame structure will be discussed below.
A multiple access scheme component may specify multiple access technique options, including technologies defining how communicating devices share a common physical channel, such as: Time Division Multiple Access (TDMA), Frequency Division Multiple Access (FDMA), Code Division Multiple Access (CDMA), Single Carrier Frequency Division Multiple Access (SC-FDMA), Low Density Signature Multicarrier Code Division Multiple Access (LDS-MC-CDMA), Non-Orthogonal Multiple Access (NOMA), Pattern Division Multiple Access (PDMA), Lattice Partition Multiple Access (LPMA), Resource Spread Multiple Access (RSMA), and Sparse Code Multiple Access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources, and cognitive radio-based access.
A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission, and a re-transmission mechanism.
A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes, and polar codes. Modulation may refer, simply, to the constellation (including, for example, the modulation technique and order), or more specifically to various types of advanced modulation methods such as hierarchical modulation and low PAPR modulation.

In some embodiments, the air interface may be a “one-size-fits-all concept”. For example, the components within the air interface cannot be changed or adapted once the air interface is defined. In some implementations, only limited parameters or modes of an air interface, such as a cyclic prefix (CP) length or a multiple input multiple output (MIMO) mode, can be configured. In some embodiments, an air interface design may provide a unified or flexible framework to support below 6 GHz and beyond 6 GHz frequency (e.g., mmWave) bands for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain, and a frequency domain self-contained design may support more flexible radio access network (RAN) slicing through channel resource sharing between different services in both frequency and time.

### Frame Structure

A frame structure is a feature of the wireless communication physical layer that defines a time domain signal transmission structure, e.g. to allow for timing reference and timing alignment of basic time domain transmission units. Wireless communication between communicating devices may occur on time-frequency resources governed by a frame structure. The frame structure may sometimes instead be called a radio frame structure.

Depending upon the frame structure and/or configuration of frames in the frame structure, frequency division duplex (FDD) and/or time-division duplex (TDD) and/or full duplex (FD) communication may be possible. FDD communication is when transmissions in different directions (e.g. uplink vs. downlink) occur in different frequency bands. TDD communication is when transmissions in different directions (e.g. uplink vs. downlink) occur over different time durations. FD communication is when transmission and reception occurs on the same time-frequency resource, i.e. a device can both transmit and receive on the same frequency resource concurrently in time.

One example of a frame structure is a frame structure in long-term evolution (LTE) having the following specifications: each frame is 10 ms in duration; each frame has 10 subframes, which are each 1 ms in duration; each subframe includes two slots, each of which is 0.5 ms in duration; each slot is for transmission of 7 OFDM symbols (assuming normal CP); each OFDM symbol has a symbol duration and a particular bandwidth (or partial bandwidth or bandwidth partition) related to the number of subcarriers and subcarrier spacing; the frame structure is based on OFDM waveform parameters such as subcarrier spacing and CP length (where the CP has a fixed length or limited length options); and the switching gap between uplink and downlink in TDD has to be the integer time of OFDM symbol duration.

Another example of a frame structure is a frame structure in new radio (NR) having the following specifications: multiple subcarrier spacings are supported, each subcarrier spacing corresponding to a respective numerology; the frame structure depends on the numerology, but in any case the frame length is set at 10 ms, and consists of ten subframes of 1 ms each; a slot is defined as 14 OFDM symbols, and slot length depends upon the numerology. For example, the NR frame structure for normal CP 15 kHz subcarrier spacing (“numerology 1”) and the NR frame structure for normal CP 30 kHz subcarrier spacing (“numerology 2”) are different. For 15 kHz subcarrier spacing a slot length is 1 ms, and for 30 kHz subcarrier spacing a slot length is 0.5 ms. The NR frame structure may have more flexibility than the LTE frame structure.

Another example of a frame structure is an example flexible frame structure, e.g. for use in a 6G network or later. In a flexible frame structure, a symbol block may be defined as the minimum duration of time that may be scheduled in the flexible frame structure. A symbol block may be a unit of transmission having an optional redundancy portion (e.g. CP portion) and an information (e.g. data) portion. An OFDM symbol is an example of a symbol block. A symbol block may alternatively be called a symbol. Embodiments of flexible frame structures include different parameters that may be configurable, e.g. frame length, subframe length, symbol block length, etc. A non-exhaustive list of possible configurable parameters in some embodiments of a flexible frame structure include:
(1) Frame: The frame length need not be limited to 10 ms, and the frame length may be configurable and change over time. In some embodiments, each frame includes one or multiple downlink synchronization channels and/or one or multiple downlink broadcast channels, and each synchronization channel and/or broadcast channel may be transmitted in a different direction by different beamforming. The frame length may be more than one possible value and configured based on the application scenario. For example, autonomous vehicles may require relatively fast initial access, in which case the frame length may be set as 5 ms for autonomous vehicle applications. As another example, smart meters on houses may not require fast initial access, in which case the frame length may be set as 20 ms for smart meter applications.
(2) Subframe duration: A subframe might or might not be defined in the flexible frame structure, depending upon the implementation. For example, a frame may be defined to include slots, but no subframes. In frames in which a subframe is defined, e.g. for time domain alignment, then the duration of the subframe may be configurable. For example, a subframe may be configured to have a length of 0.1 ms or 0.2 ms or 0.5 ms or 1 ms or 2 ms or 5 ms, etc. In some embodiments, if a subframe is not needed in a particular scenario, then the subframe length may be defined to be the same as the frame length or not defined.
(3) Slot configuration: A slot might or might not be defined in the flexible frame structure, depending upon the implementation. In frames in which a slot is defined, then the definition of a slot (e.g. in time duration and/or in number of symbol blocks) may be configurable. In one embodiment, the slot configuration is common to all UEs or a group of UEs. For this case, the slot configuration information may be transmitted to UEs in a broadcast channel or common control channel(s). In other embodiments, the slot configuration may be UE specific, in which case the slot configuration information may be transmitted in a UE-specific control channel. In some embodiments, the slot configuration signaling can be transmitted together with frame configuration signaling and/or subframe configuration signaling. In other embodiments, the slot configuration can be transmitted independently from the frame configuration signaling and/or subframe configuration signaling. In general, the slot configuration may be system common, base station common, UE group common, or UE specific.
(4) Subcarrier spacing (SCS): SCS is one parameter of scalable numerology which may allow the SCS to possibly range from 15 KHz to 480 KHz. The SCS may vary with the frequency of the spectrum and/or maximum UE speed to minimize the impact of the Doppler shift and phase noise. In some examples, there may be separate transmission and reception frames, and the SCS of symbols in the reception frame structure may be configured independently from the SCS of symbols in the transmission frame structure. The SCS in a reception frame may be different from the SCS in a transmission frame. In some examples, the SCS of each transmission frame may be half the SCS of each reception frame. If the SCS between a reception frame and a transmission frame is different, the difference does not necessarily have to scale by a factor of two, e.g. if more flexible symbol durations are implemented using inverse discrete Fourier transform (IDFT) instead of fast Fourier transform (FIT). Additional examples of frame structures can be used with different SCSs.
(5) Flexible transmission duration of basic transmission unit: The basic transmission unit may be a symbol block (alternatively called a symbol), which in general includes a redundancy portion (referred to as the CP) and an information (e.g. data) portion, although in some embodiments the CP may be omitted from the symbol block. The CP length may be flexible and configurable. The CP length may be fixed within a frame or flexible within a frame, and the CP length may possibly change from one frame to another, or from one group of frames to another group of frames, or from one subframe to another subframe, or from one slot to another slot, or dynamically from one scheduling to another scheduling. The information (e.g. data) portion may be flexible and configurable. Another possible parameter relating to a symbol block that may be defined is ratio of CP duration to information (e.g. data) duration. In some embodiments, the symbol block length may be adjusted according to: channel condition (e.g. multi-path delay, Doppler); and/or latency requirement; and/or available time duration. As another example, a symbol block length may be adjusted to fit an available time duration in the frame.
(6) Flexible switch gap: A frame may include both a downlink portion for downlink transmissions from a base station, and an uplink portion for uplink transmissions from UEs. A gap may be present between each uplink and downlink portion, which is referred to as a switching gap. The switching gap length (duration) may be configurable. A switching gap duration may be fixed within a frame or flexible within a frame, and a switching gap duration may possibly change from one frame to another, or from one group of frames to another group of frames, or from one subframe to another subframe, or from one slot to another slot, or dynamically from one scheduling to another scheduling.

### Cell/Carrier/Bandwidth Parts (BWPs)/Occupied Bandwidth

A device, such as a base station, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, e.g. the center or lowest or highest frequency of the carrier. A carrier may be on licensed or unlicensed spectrum. Wireless communication with the device may also or instead occur over one or more bandwidth parts (BWPs). For example, a carrier may have one or more BWPs. More generally, wireless communication with the device may occur over spectrum. The spectrum may comprise one or more carriers and/or one or more BWPs.

A cell may include one or multiple downlink resources and optionally one or multiple uplink resources, or a cell may include one or multiple uplink resources and optionally one or multiple downlink resources, or a cell may include both one or multiple downlink resources and one or multiple uplink resources. As an example, a cell might only include one downlink carrier/BWP, or only include one uplink carrier/BWP, or include multiple downlink carriers/BWPs, or include multiple uplink carriers/BWPs, or include one downlink carrier/BWP and one uplink carrier/BWP, or include one downlink carrier/BWP and multiple uplink carriers/BWPs, or include multiple downlink carriers/BWPs and one uplink carrier/BWP, or include multiple downlink carriers/BWPs and multiple uplink carriers/BWPs. In some embodiments, a cell may instead or additionally include one or multiple sidelink resources, including sidelink transmitting and receiving resources.

A BWP is a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

In some embodiments, a carrier may have one or more BWPs, e.g. a carrier may have a bandwidth of 20 MHz and consist of one BWP, or a carrier may have a bandwidth of 80 MHz and consist of two adjacent contiguous BWPs, etc. In other embodiments, a BWP may have one or more carriers, e.g. a BWP may have a bandwidth of 40 MHz and consists of two adjacent contiguous carriers, where each carrier has a bandwidth of 20 MHz. In some embodiments, a BWP may comprise non-contiguous spectrum resources which consists of non-contiguous multiple carriers, where the first carrier of the non-contiguous multiple carriers may be in mmW band, the second carrier may be in a low band (such as 2 GHz band), the third carrier (if it exists) may be in THz band, and the fourth carrier (if it exists) may be in visible light band. Resources in one carrier which belong to the BWP may be contiguous or non-contiguous. In some embodiments, a BWP has non-contiguous spectrum resources on one carrier.

Wireless communication may occur over an occupied bandwidth. The occupied bandwidth may be defined as the width of a frequency band such that, below the lower and above the upper frequency limits, the mean powers emitted are each equal to a specified percentage □/2 of the total mean transmitted power, for example, the value of □/2 is taken as 0.5%.

The carrier, the BWP, or the occupied bandwidth may be signaled by a network device (e.g. base station) dynamically, e.g. in physical layer control signaling such as Downlink Control Information (DCI), or semi-statically, e.g. in radio resource control (RRC) signaling or in the medium access control (MAC) layer, or be predefined based on the application scenario; or be determined by the UE as a function of other parameters that are known by the UE, or may be fixed, e.g. by a standard.

Artificial Intelligence (AI) and/or Machine Learning (ML)

The number of new devices in future wireless networks is expected to increase exponentially and the functionalities of the devices are expected to become increasingly diverse. Also, many new applications and use cases are expected to emerge with more diverse quality of service demands than those of 5G applications/use cases. These will result in new key performance indications (KPIs) for future wireless networks (for example, a 6G network) that can be extremely challenging. AI technologies, such as ML technologies (e.g., deep learning), have been introduced to telecommunication applications with the goal of improving system performance and efficiency.

In addition, advances continue to be made in antenna and bandwidth capabilities, thereby allowing for possibly more and/or better communication over a wireless link. Additionally, advances continue in the field of computer architecture and computational power, e.g. with the introduction of general-purpose graphics processing units (GP-GPUs). Future generations of communication devices may have more computational and/or communication ability than previous generations, which may allow for the adoption of AI for implementing air interface components. Future generations of networks may also have access to more accurate and/or new information (compared to previous networks) that may form the basis of inputs to AI models, e.g.: the physical speed/velocity at which a device is moving, a link budget of the device, the channel conditions of the device, one or more device capabilities and/or a service type that is to be supported, sensing information, and/or positioning information, etc. To obtain sensing information, a TRP may transmit a signal to target object (e.g. a suspected UE), and based on the reflection of the signal the TRP or another network device computes the angle (for beamforming for the device), the distance of the device from the TRP, and/or Doppler shifting information. Positioning information is sometimes referred to as localization, and it may be obtained in a variety of ways, e.g. a positioning report from a UE (such as a report of the UE's GPS coordinates), use of positioning reference signals (PRS), using the sensing described above, tracking and/or predicting the position of the device, etc.

AI technologies (which encompass ML technologies) may be applied in communication, including AI-based communication in the physical layer and/or AI-based communication in the MAC layer. For the physical layer, the AI communication may aim to optimize component design and/or improve the algorithm performance. For example, AI may be applied in relation to the implementation of: channel coding, channel modelling, channel estimation, channel decoding, modulation, demodulation, MIMO, waveform, multiple access, physical layer element parameter optimization and update, beam forming, tracking, sensing, and/or positioning, etc. For the MAC layer, the AI communication may aim to utilize the AI capability for learning, prediction, and/or making a decision to solve a complicated optimization problem with possible better strategy and/or optimal solution, e.g. to optimize the functionality in the MAC layer. For example, AI may be applied to implement: intelligent TRP management, intelligent beam management, intelligent channel resource allocation, intelligent power control, intelligent spectrum utilization, intelligent MCS, intelligent HARQ strategy, and/or intelligent transmission/reception mode adaption, etc.

In some embodiments, an AI architecture may involve multiple nodes, where the multiple nodes may possibly be organized in one of two modes, i.e., centralized and distributed, both of which may be deployed in an access network, a core network, or an edge computing system or third party network. A centralized training and computing architecture is restricted by possibly large communication overhead and strict user data privacy. A distributed training and computing architecture may comprise several frameworks, e.g., distributed machine learning and federated learning. In some embodiments, an AI architecture may comprise an intelligent controller which can perform as a single agent or a multi-agent, based on joint optimization or individual optimization. New protocols and signaling mechanisms are desired so that the corresponding interface link can be personalized with customized parameters to meet particular requirements while minimizing signaling overhead and maximizing the whole system spectrum efficiency by personalized AI technologies.

In some embodiments herein, new protocols and signaling mechanisms are provided for operating within and switching between different modes of operation for AI training, including between training and normal operation modes, and for measurement and feedback to accommodate the different possible measurements and information that may need to be fed back, depending upon the implementation.

### AI Training

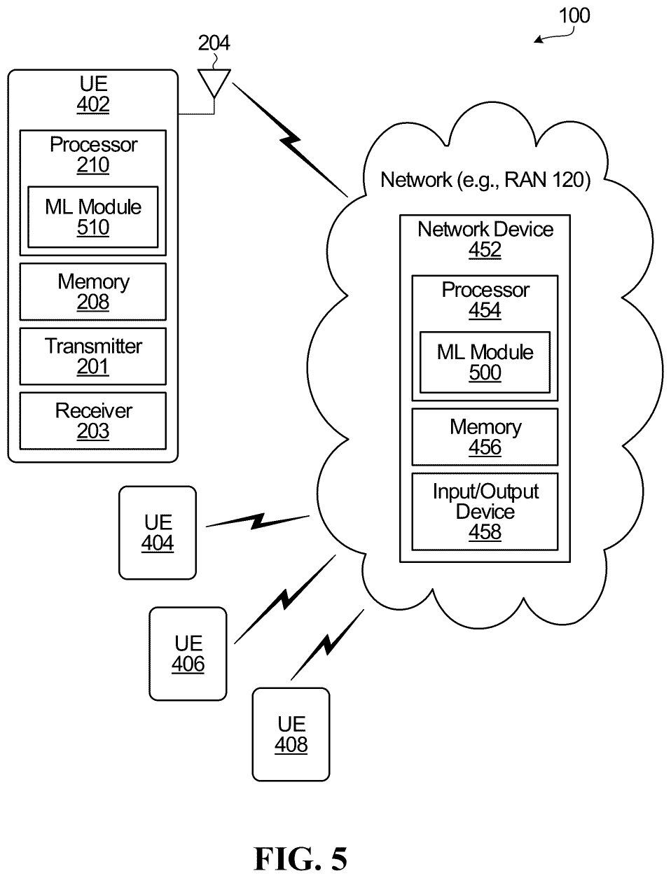

Referring again to FIGS. 1 and 2, embodiments of the present disclosure may be used to implement AI training involving two or more communicating devices in the communication system 100. For example, FIG. 5 illustrates four EDs communicating with a network device 452 in the communication system 100, according to one embodiment. The four EDs are each illustrated as a respective different UE, and will hereafter be referred to as UEs 402, 404, 406, and 408. However, the EDs do not necessarily need to be UEs.

The network device 452 is part of a network (e.g. a radio access network 120). The network device 452 may be deployed in an access network, a core network, or an edge computing system or third-party network, depending upon the implementation. The network device 452 might be (or be part of) a T-TRP or a server. In one example, the network device 452 can be (or be implemented within) T-TRP 170 or NT-TRP 172. In another example, the network device 452 can be a T-TRP controller and/or a NT-TRP controller which can manage T-TRP 170 or NT-TRP 172. In some embodiments, the components of the network device 452 might be distributed. The UEs 402, 404, 406, and 408 might directly communicate with the network device 452, e.g. if the network device 452 is part of a T-TRP serving the UEs 402, 404, 406, and 408. Alternatively, the UEs 402, 404, 406, and 408 might communicate with the network device 352 via one or more intermediary components, e.g. via a T-TRP and/or via a NT-TRP, etc. For example, the network device 452 may send and/or receive information (e.g. control signaling, data, training sequences, etc.) to/from one or more of the UEs 402, 404, 406, and 408 via a backhaul link and wireless channel interposed between the network device 452 and the UEs 402, 404, 406, and 408.

Each UE 402, 404, 406, and 408 includes a respective processor 210, memory 208, transmitter 201, receiver 203, and one or more antennas 204 (or alternatively panels), as described above. Only the processor 210, memory 208, transmitter 201, receiver 203, and antenna 204 for UE 402 are illustrated for simplicity, but the other UEs 404, 406, and 408 also include the same respective components.

For each UE 402, 404, 406, and 408, the communications link between that UE and a respective TRP in the network is an air interface. The air interface generally includes a number of components and associated parameters that collectively specify how a transmission is to be sent and/or received over the wireless medium.

The processor 210 of a UE in FIG. 5 implements one or more air interface components on the UE-side. The air interface components configure and/or implement transmission and/or reception over the air interface. Examples of air interface components are described herein. An air interface component might be in the physical layer, e.g. a channel encoder (or decoder) implementing the coding component of the air interface for the UE, and/or a modulator (or demodulator) implementing the modulation component of the air interface for the UE, and/or a waveform generator implementing the waveform component of the air interface for the UE, etc. An air interface component might be in or part of a higher layer, such as the MAC layer, e.g. a module that implements channel prediction/tracking, and/or a module that implements a retransmission protocol (e.g. that implements the HARQ protocol component of the air interface for the UE), etc. The processor 210 also directly performs (or controls the UE to perform) the UE-side operations described herein.

The network device 452 includes a processor 454, a memory 456, and an input/output device 458. The processor 454 implements or instructs other network devices (e.g. T-TRPs) to implement one or more of the air interface components on the network side. An air interface component may be implemented differently on the network-side for one UE compared to another UE. The processor 454 directly performs (or controls the network components to perform) the network-side operations described herein.

The processor 454 may be implemented by the same or different one or more processors that are configured to execute instructions stored in a memory (e.g. in memory 456). Alternatively, some or all of the processor 454 may be implemented using dedicated circuitry, such as a programmed FPGA, a GPU, or an ASIC. The memory 456 may be implemented by volatile and/or non-volatile storage. Any suitable type of memory may be used, such as RAM, ROM, hard disk, optical disc, on-processor cache, and the like.

The input/output device 458 permits interaction with other devices by receiving (inputting) and transmitting (outputting) information. In some embodiments, the input/output device 458 may be implemented by a transmitter and/or a receiver (or a transceiver), and/or one or more interfaces (such as a wired interface, e.g. to an internal network or to the internet, etc). In some implementations, the input/output device 458 may be implemented by a network interface, which may possibly be implemented as a network interface card (NIC), and/or a computer port (e.g. a physical outlet to which a plug or cable connects), and/or a network socket, etc., depending upon the implementation.

The network device 452 and the UE 402 have the ability to implement one or more AI-enabled processes. In particular, in the embodiment in FIG. 5 the network device 452 and the UE 402 include ML modules 410 and 460, respectively. The ML module 410 is implemented by processor 210 of UE 402 and the ML module 460 is implemented by processor 454 of network device 452 and therefore the ML module 410 is shown as being within processor 210 and the ML module 460 is shown as being with processor 454 in FIG. 5. The ML modules 410 and 460 execute one or more AI/ML algorithms to perform one or more AI-enabled processes, e.g., AI-enabled link adaptation to optimize communication links between the network and the UE 402, for example.

The ML modules 410 and 460 may be implemented using an AI model. The term AI model may refer to a computer algorithm that is configured to accept defined input data and output defined inference data, in which parameters (e.g., weights) of the algorithm can be updated and optimized through training (e.g., using a training dataset, or using real-life collected data). An AI model may be implemented using one or more neural networks (e.g., including deep neural networks (DNN), recurrent neural networks (RNN), convolutional neural networks (CNN), and combinations thereof) and using various neural network architectures (e.g., autoencoders, generative adversarial networks, etc.). Various techniques may be used to train the AI model, in order to update and optimize its parameters. For example, backpropagation is a common technique for training a DNN, in which a loss function is calculated between the inference data generated by the DNN and some target output (e.g., ground-truth data). A gradient of the loss function is calculated with respect to the parameters of the DNN, and the calculated gradient is used (e.g., using a gradient descent algorithm) to update the parameters with the goal of minimizing the loss function.

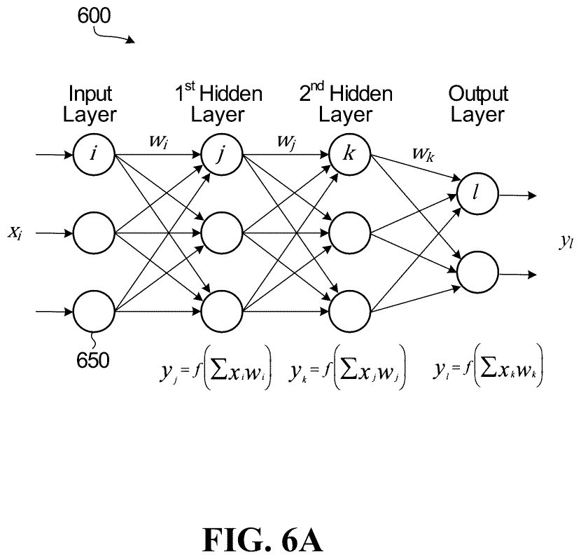

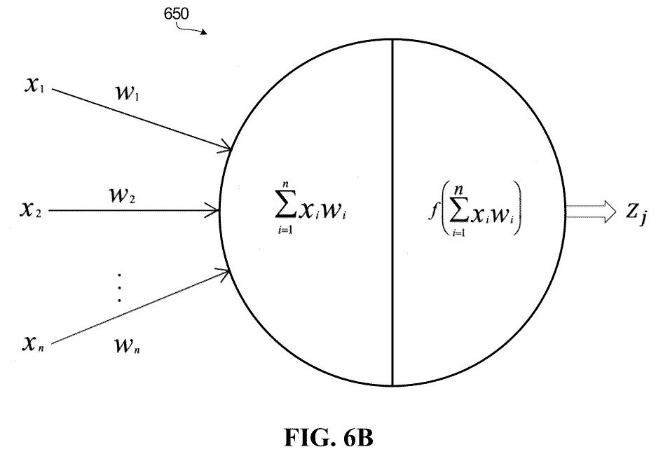

In some embodiments, an AI model encompasses neural networks, which are used in machine learning. A neural network is composed of a plurality of computational units (which may also be referred to as neurons), which are arranged in one or more layers. The process of receiving an input at an input layer and generating an output at an output layer may be referred to as forward propagation. In forward propagation, each layer receives an input (which may have any suitable data format, such as vector, matrix, or multidimensional array) and performs computations to generate an output (which may have different dimensions than the input). The computations performed by a layer typically involves applying (e.g., multiplying) the input by a set of weights (also referred to as coefficients). With the exception of the first layer of the neural network (i.e., the input layer), the input to each layer is the output of a previous layer. A neural network may include one or more layers between the first layer (i.e., input layer) and the last layer (i.e., output layer), which may be referred to as inner layers or hidden layers. For example, FIG. 6A depicts an example of a neural network 600 that includes an input layer, an output layer and two hidden layers. In this example, it can be seen that the output of each of the three neurons in the input layer of the neural network 600 is included in the input vector to each of the three neurons in the first hidden layer. Similarly, the output of each of the three neurons of the first hidden layer is included in an input vector to each of the three neurons in the second hidden layer and the output of each of the three neurons of the second hidden layer is included in an input vector to each of the two neurons in the output layer. As noted above, the fundamental computation unit in a neural network is the neuron, as shown at 650 in FIG. 6A. FIG. 6B illustrates an example of a neuron 650 that may be used as a building block for the neural network 600. As shown in FIG. 6B, in this example the neuron 650 takes a vector x as an input and performs a dot-product with an associated vector of weights w. The final output z of the neuron is the result of an activation function ƒ( ) on the dot product. Various neural networks may be designed with various architectures (e.g., various numbers of layers, with various functions being performed by each layer).

A neural network is trained to optimize the parameters (e.g., weights) of the neural network. This optimization is performed in an automated manner and may be referred to as machine learning. Training of a neural network involves forward propagating an input data sample to generate an output value (also referred to as a predicted output value or inferred output value), and comparing the generated output value with a known or desired target value (e.g., a ground-truth value). A loss function is defined to quantitatively represent the difference between the generated output value and the target value, and the goal of training the neural network is to minimize the loss function. Backpropagation is an algorithm for training a neural network. Backpropagation is used to adjust (also referred to as update) a value of a parameter (e.g., a weight) in the neural network, so that the computed loss function becomes smaller. Backpropagation involves computing a gradient of the loss function with respect to the parameters to be optimized, and a gradient algorithm (e.g., gradient descent) is used to update the parameters to reduce the loss function. Backpropagation is performed iteratively, so that the loss function is converged or minimized over a number of iterations. After a training condition is satisfied (e.g., the loss function has converged, or a predefined number of training iterations have been performed), the neural network is considered to be trained. The trained neural network may be deployed (or executed) to generate inferred output data from input data. In some embodiments, training of a neural network may be ongoing even after a neural network has been deployed, such that the parameters of the neural network may be repeatedly updated with up-to-date training data.

Referring again to FIG. 5, in some embodiments the UE 402 and network device 452 may exchange information for the purposes of training. The information exchanged between the UE 402 and the network device 452 is implementation specific, and it might not have a meaning understandable to a human (e.g. it might be intermediary data produced during execution of a ML algorithm). It might also or instead be that the information exchanged is not predefined by a standard, e.g. bits may be exchanged, but the bits might not be associated with a predefined meaning. In some embodiments, the network device 452 may provide or indicate, to the UE 402, one or more parameters to be used in the ML module 410 implemented at the UE 402. As one example, the network device 452 may send or indicate updated neural network weights to be implemented in a neural network executed by the ML module 410 on the UE-side, in order to try to optimize one or more aspects of modulation and/or coding used for communication between the UE 402 and a T-TRP or NT-TRP.

In some embodiments, the UE 402 may implement AI itself, e.g. perform learning, whereas in other embodiments the UE 402 may not perform learning itself but may be able to operate in conjunction with an AI implementation on the network side, e.g. by receiving configurations from the network for an AI model (such as a neural network or other ML algorithm) implemented by the ML module 410, and/or by assisting other devices (such as a network device or other AI capable UE) to train an AI model (such as a neural network or other ML algorithm) by providing requested measurement results or observations. For example, in some embodiments, UE 402 itself may not implement learning or training, but the UE 402 may receive trained configuration information for an ML model determined by the network device 452 and execute the model.

Although the example in FIG. 5 assumes AI/ML capability on the network side, it might be the case that the network does not itself perform training/learning, and instead a UE may perform learning/training itself, possibly with dedicated training signals sent from the network. In other embodiments, end-to-end (E2E) learning may be implemented by the UE and the network device 452.

Using AI, e.g. by implementing an AI model as described above, various processes, such as link adaptation, may be AI-enabled. Some examples of possible AI/ML training processes and over the air information exchange procedures between devices during training phases to facilitate AI-enabled processes in accordance with embodiments of the present disclosure are described below.

In existing online AI model training processes, HARQ-ACK feedback and retransmission are used in an effort to ensure that the training data that is transmitted between a transmitting device and a receiving device as part of the training process are successfully decoded by the receiving device without error.

For example, referring again to FIG. 5, for wireless federated learning (FL), the network device 452 may initialize a global AI/ML model implemented by the ML module 500, sample a group of UEs, such as the four UEs 402, 404, 406 and 408 shown in FIG. 5, and broadcast the global AI/ML model parameters to the UEs. Each of the UEs 402, 404, 406 and 408 may then initialize its local AI/ML model using the global AI/ML model parameters, and update (train) its local AI/ML model using its own data. Then each of the UEs 402, 404, 406 and 408 may report its updated local AI/ML model's parameters to the network device 452. The network device 452 may then aggregate the updated parameters reported from UEs 402, 404, 406 and 408 and update the global AI/ML model. The aforementioned procedure is one iteration of FL-based AI/ML model training procedure. The network device 452 and the UEs 402, 404, 406 and 408 perform multiple iterations until the AI/ML model has converged sufficiently to satisfy one or more training goals/criteria.

For the downlink (DL) transmissions in FL, e.g., for the transmissions of the global model parameters from the network device 452 to the UEs 402, 404, 406 and 408 in the above example, if one of the UEs 402, 404, 406 and 408 is experiencing poor channel quality (e.g., high interference and/or fading), a DL transmission to that UE is likely to fail and result in the UE reporting a NACK to request a retransmission. This can result in many retransmissions during the training procedure and the associated communication overhead will therefore be very large. Furthermore, in synchronous FL-based AI/ML training procedures, the network device 452 would start the next iteration for training until all UEs that are participating in the training successfully decode the DL transmission and report the updated local model parameters for the current iteration. In practice, this means that the transmission delay from iteration-to-iteration is typically dominated by the UE having the highest packet loss rate, which can result in large delays for the AI/ML model training.

Other than FL, large communication overhead and large learning delay also exists in other learning methods. For example, in distributed learning, UEs and a network device collaboratively train AI models in a manner similar to FL. The primary difference between FL and distributed learning being that in FL the DL transmissions are done via broadcast or groupcast transmissions, whereas unicast transmissions are used for DL in distributed learning.

Another drawback of existing AI/ML model training procedures is related to the payload size of exchanged data, which is typically very large. For example, in many cases the exchanged data includes hundreds or thousands of AI/ML model parameters, e.g. gradients, connection weights, biases, etc. Therefore, due to the often unreliable nature of transmissions in wireless communication and the typically large data volume for the exchanged data between devices for AI training, the air interface resource overhead required for AI/ML model training can be very large. Accordingly, techniques to reduce the overhead and delays associated with online AI/ML model training are highly desirable.

### Reliability Adaptation for AI Training

The present disclosure describes examples of AI/ML model training procedures that avoid or at least mitigate one or more of the foregoing problems with conventional AI/ML model training procedures. For example, as discussed in further detail below, in some embodiments described herein different modes of communication are used at different times/phases of an AI/ML model training procedure. For example, according to a first aspect of the present disclosure, a first device that is involved in an AI/ML model training procedure with a second device may communicate data or control information with the second device in accordance with different communication modes that are reflective of different levels of reliability during different phases of the AI/ML model training procedure. For example, the different communication modes may be different reliability modes that include at least a first reliability mode and a second reliability mode, wherein the second reliability mode differs from the first reliability mode in terms of: a quantization level used to quantize values of variables in the data or control information and/or a HARQ feedback and retransmission process for selective retransmission of one or portions of the data or control information. In general, the communication mode adaption techniques described herein may be applied to any communications between two devices, including downlink, uplink and/or sidelink communications. For example, in some embodiments the first device may be an ED, e.g. a UE 404, and the second device may be a network device, e.g. a T-TRP 170, NT-TRP 172 or network device 452. In other embodiments, the first device may be a network device and the second device may be an ED. In still other embodiments, both devices may be EDs.

For example, at an early phase of training, exchanged AI/ML model training data is most likely not completely accurate/informative because the AI/ML models involved in the training procedure have not yet converged. In this stage, a low-reliability mode may be used that may be characterized by one or more of the following communication properties:
No HARQ feedback or retransmission process is used to reduce overhead; and/or
Low-precision quantization is used for the exchanged data (e.g., gradient, weight, bias, etc.).

However, at a certain point in the training procedure (for example, if an average local validation loss is no longer meaningfully improving, e.g., if the validation loss improvement from one training iteration to the next falls below a certain threshold), the device may be switched to a second reliability mode, e.g., a high-reliability mode, to converge the AI training. For example, the high-reliability mode may be characterized by one or more of the following communication properties that differ from the communication properties of the low-reliability mode:
Retransmissions based on HARQ feedback may be used to ensure transmitted training data is successfully decoded by the receiving device; and/or
High-precision quantization may be used for the exchanged data.

In such embodiments, switching between low-reliability mode and high-reliability mode could be semi-static or dynamic, as discussed in further detail below.

With respect to the different quantization precision levels that may be used in different reliability modes, it is noted that the terms low-precision quantization and high-precision quantization are used herein in a relative sense. In particular, low-precision quantization is used herein to mean that a smaller number of bits is used to express the value of a variable, whereas high-precision quantization is used herein to mean that more bits are used to express the value of a variable in order to express the exact value of the variable more precisely. For example, for expression of the weight of a connection, low-precision quantization may use only 1 bit, whereas high-precision quantization may use 2 bits. The following Table 1 provides an example of such an implementation, including a possible bit meaning:

TABLE 1

| Quantization level | The value of weight |
|---|---|
| Low-precision | 0: X1 in case weight < (X1 + X4)/2 |
| quantization (1 bit) | 1: X4 in case weight >= (X1 + X4)/2 |
| high-precision | 00: X1 in case weight < (X1 + X2)/2 |
| quantization (2 bits) | 01: X2 in case (X1 + X2)/2 =< weight <= (X2 + |
| | X3)/2 |
| | 10: X3 in case (X2 + X3)/2 =< weight <= (X3 + |
| | X4)/2 |
| | 11: X4 in case weight >= (X3 + X4)/2 |
| | Note: X1 < X2 < X3 < X4 |

It is noted that embodiments of the present disclosure are not limited to two reliability modes. For example, in some implementations there may be at least three different modes to achieve different reliabilities, such as the following three non-limiting examples:
low-reliability mode: no HARQ feedback and no retransmission, and/or low-precision quantization for the data transmission between devices
medium-reliability mode: no HARQ-ACK feedback and no retransmission, and high-precision quantization for the data transmission between devices; or with HARQ feedback and retransmission and low-precision quantization
high-reliability mode: with HARQ-ACK feedback and retransmission, and/or high-precision quantization for the data transmission between devices.

It should be noted that the above three modes are merely examples; more modes could be included in some implementations, e.g. medium-precision quantization and other combinations between HARQ methods and different quantization methods.

It should also be noted that although many of the following examples are described in the context of federated learning-based or distributed learning-based AI/ML model training procedures, the techniques described herein can also be applied to AI training in other learning methods, e.g. centralized learning, auto-encoder, DNN (Deep Neural Network), CNN (convolutional neural network), etc.

It should also be noted that embodiments of the present disclosure are not limited to switching from low-reliability mode to high-reliability mode. For example, switching from high-reliability mode to low-reliability mode is also possible. Furthermore, in embodiments that include more than two communication modes, it may be possible to switch from each communication mode to any of the other communication modes. For example, in the example described above that includes low-reliability mode, medium-reliability mode and high-reliability mode, it may be possible to switch from low-reliability mode to medium-reliability mode and from low-reliability mode to high-reliability mode. Similarly, it may be possible to switch from high-reliability mode to low-reliability mode and from high-reliability mode to medium-reliability mode. In addition, communicating devices may switch between communication modes multiple times. For example, two communicating devices participating in an AI/ML model training procedure may switch communication modes multiple times (e.g., from low-reliability mode to high-reliability mode or vice versa) during the training procedure.

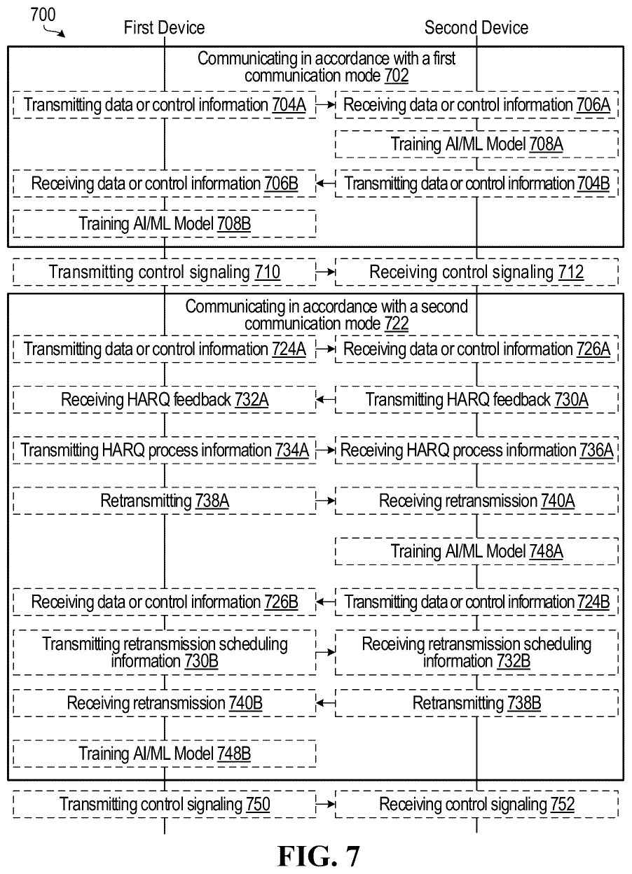

FIG. 7 illustrates a signal flow diagram 700 for a method performed by a first device and a second device, according to one aspect of the present disclosure. In some embodiments, the first device may be a network device, e.g., a TRP 452, and the second device may be an ED, e.g., a UE 402, although not necessarily. For example, in other embodiments, the first device may be an ED and the second device may be a network device. In still other embodiments, both devices may be EDs.

At step 702, the first device communicates data or control information with the second device in accordance with a first communication mode. The first communication mode is one of a plurality of communication modes that includes at least the first communication mode and a second communication mode differing from the first communication mode in terms of: a quantization level used to quantize values of variables in the data or control information; and/or a HARQ feedback and retransmission mode for selective retransmission of one or more portions of the data or control information.

Communicating data or control information with the second device in accordance with the first communication mode at 702 may involve the first device transmitting data or control information to the second device, as optionally indicated at 704A, and the second device receiving the data or control information, as optionally indicated at 706A. In some embodiments, transmission of the data or control information at 704A is scheduled by DCI, wherein a CRC value of the DCI is scrambled with an RNTI that is different from a Cell RNTI (C-RNTI).

Communicating data or control information with the second device at 702 may also or instead involve the second device transmitting data or control information to the first device, as optionally indicated at 704B, and the first device receiving the data or control information, as optionally indicated at 706B.

At step 722, the first device switches from communicating data or control information with the second device in accordance with the first communication mode to communicating data or control information with the second device in accordance with the second communication mode. In some embodiments, switching from the first communication mode to the second communication mode may occur after a predetermined or preconfigured AI/ML model training time has elapsed or after a number of AI/ML model training iterations have occurred, for example. In addition or instead, the switch may be triggered by control signaling. For example, in some embodiments, the first device may transmit control signaling containing a switching instruction to the second device, as optionally indicated at 710. In such embodiments, after the control signaling is transmitted by the first device at 710 and received by the second device at 712, the first device and the second device may switch from the first communication mode to the second communication mode in accordance with the switching instruction contained in the control signaling communicated at 710, 712.

Communicating data or control information with the second device in accordance with the second communication mode at 722 may involve the first device transmitting data or control information to the second device, as optionally indicated at 724A, and the second device receiving the data or control information, as optionally indicated at 726A. Communicating data or control information with the second device at 702 may also or instead involve the second device transmitting data or control information to the first device, as optionally indicated at 724B, and the first device receiving the data or control information, as optionally indicated at 726B.

In some embodiments, in the first communication mode, a first HARQ feedback and retransmission mode is used, wherein, in the first HARQ feedback and retransmission mode, there is no HARQ feedback process and no retransmission of the data or control information between the first device and the second device. In contrast, a second HARQ feedback and retransmission mode may be used in the second communication mode, wherein, in the second HARQ feedback and retransmission mode, there is a HARQ feedback process to request retransmission of one or more portions of the data or control information. For example, if the second device fails to successfully receive one or more portions of the data or control information at 726A, the second device may transmit HARQ feedback information to the first device identifying one or more portions of data that was not successfully received by the second device as optionally indicated at 730A. In some embodiments, the HARQ feedback information received at 730A may include, for each portion of the data that was not successfully received by the second device, importance indicator information corresponding to the unsuccessfully received portion. For example, the importance indicator information corresponding to an unsuccessfully received portion may indicate whether the unsuccessfully received portion is important to AI/ML model training at the second device. In such embodiments, after receiving the HARQ feedback information at 732A, the first device may transmit HARQ process information to the second device as optionally indicated at 734A. For example, the HARQ process information may identify at least one of the one or more unsuccessfully received portions of the data that will not be retransmitted by the first device. In such embodiments, the first device may retransmit a partial subset of the one or more unsuccessfully received portions, wherein the partial subset excludes the at least one unsuccessfully received portion identified in the HARQ process information. For example, the first device may transmit such a retransmission as optionally indicated at 738A, which may then be received by the second device as optionally indicated at 740A. In some embodiments, multiple retransmissions may be permitted, but a given HARQ process may be terminated after a predetermined or preconfigured number of retransmissions have occurred. In contrast, if the first device fails to successfully receive one or more portions of the data or control information at 726B, rather than transmitting HARQ feedback information to the second device, the first device may instead schedule a retransmission of at least part of the unsuccessfully received data. For example, if the first device is a network device and the second device is a UE, the first device may schedule such a retransmission by transmitting retransmission scheduling information to the second device as optionally indicated at 730B. In such embodiments, after receiving the retransmission scheduling information at 732B, the second device may retransmit the requested data in accordance with the retransmission scheduling information as optionally indicated at 738B, which may then be received by the first device as optionally indicated at 740B.

In other embodiments, there may be a HARQ feedback process in both the first communication mode and the second communication mode. For example, in some embodiments, in the first communication mode, a first HARQ feedback and retransmission mode may be used, wherein N1 retransmissions are permitted in the first HARQ feedback and retransmission mode, wherein N1 is an integer and N1≥1. In such embodiments, in the second communication mode, a second HARQ feedback and retransmission mode may be used, wherein a maximum of N2 retransmissions are permitted in the second HARQ feedback and retransmission mode, wherein N2 is an integer and N2>N1.

In some embodiments, the data or control information transmitted from the first device and received by the second device and/or the data or control information transmitted from the second device and received by the first device may include data or control information for AI/ML model training. In such embodiments, one or both of the devices may train an AI/ML model based on the data or control information communicated with the other device. For example, the second device may train an AI/ML model based on the data or control information received from the first device, as optionally indicated at 708A and 748A, and/or the first device may train an AI/ML model based on the data or control information received from the second device, as optionally indicated at 708B and 748B.

In some embodiments, the first device may transmit control signaling to the second device to end the second device's participation in an AI/ML training procedure. For example, the first device may transmit control signaling to the second device as optionally indicated at 750 that contains a stop training instruction to configure the second device to stop training of an AI/ML model at the second device. In such embodiments, after receiving the control signaling at 752, the second device may stop participating in the AI/ML training procedure. In some embodiments, the second device may stop training the AI/ML model at the second device in response to receiving the stop training instruction at 752. In other embodiments, the second device may continue to train an AI/ML model at the second device after receiving the stop training instruction at 752 but may refrain from providing AI/ML model update data to the first device.

For simplicity, the example depicted in FIG. 7 depicts operation between two communication modes, namely a first communication mode and a second communication mode. However, as noted above, in other embodiments there may be greater than two communication modes.

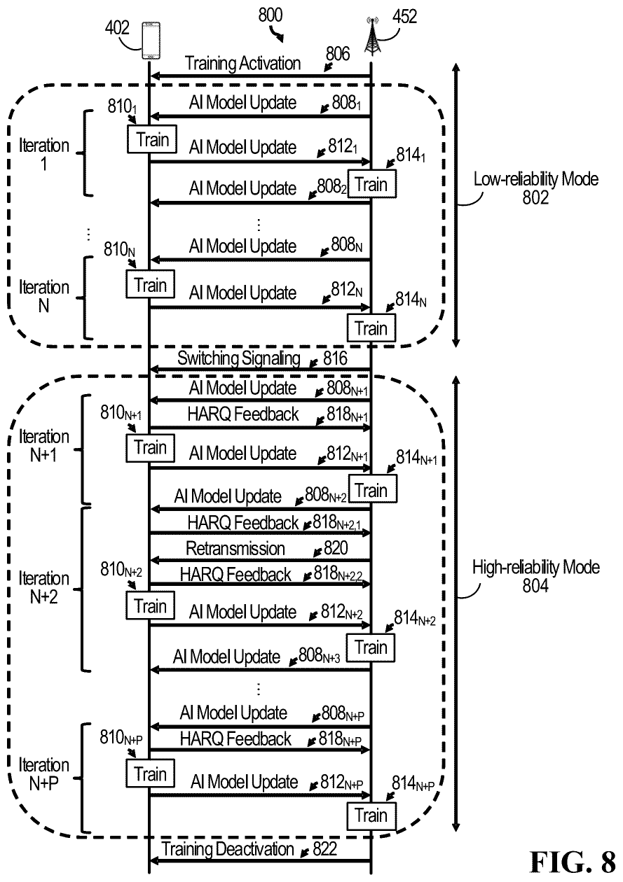

FIGS. 8 to 10 illustrate other examples of methods of communication mode adaptation performed by a first device and a second device, according to various embodiments of the present disclosure.

FIG. 8 illustrates a signal flow diagram 800 for a method performed by a pair of devices in a wireless communication network, according to one embodiment. The pair of devices may be an ED and a network device, e.g., a UE 402 and a TRP 452, although not necessarily.

For simplicity, the example depicted in FIG. 8 depicts operation between two communication modes, namely low-reliability mode 802 and high-reliability mode 804. However, as noted above, in other embodiments there may be greater than two reliability modes. In general, the reliability adaption scheme may be applied to any specific data transmissions, e.g. data exchange (including DL and UL, or sidelink) during an AI training procedure. Such data may be identified in the physical (PHY) layer. For example, the data to which the reliability adaptation scheme may be applied may be data that is scheduled by DCI whose CRC is scrambled by a specific RNTI (e.g. AI-training-RNTI). In such cases, the specific RNTI could be group common RNTI or UE-specific RNTI, for example. In the example depicted in FIG. 8, the reliability adaptation scheme is applied to DL transmissions from the network device, e.g., TRP 452, to the ED, e.g., UE 402, in the context of a federated learning-based or distributed learning-based AI/ML model training procedure. However, in some embodiments the reliability adaptation scheme may also or instead be applied to UL transmissions from an ED to a network device and/or to sidelink transmissions between EDs.

In the example shown in FIG. 8, UE 402 operates in low-reliability mode 802 by default at the start of the training procedure. In this example, the TRP 452 indicates the start of the training process by transmitting a training activation signal to the UE 402 at 806. The training activation signal could be indicated by TRP 452 through RRC, MAC-CE, or DCI signaling, for example. For example, TRP 452 could send a DCI with a CRC that is scrambled by an RNTI that is specific to AI/ML training signaling, e.g., AI-training-RNTI, to activate the training procedure. For example, some specific fields in the DCI could be set as predefined values to indicate training activation, e.g. fields of New data indicator, Redundancy version, HARQ process number, DAI, TPC for PUCCH, PUCCH resource indicator, or HARQ timing may be set to a predefined value that is understood to indicate that AI training is to be activated.

In the example shown in FIG. 8, once the AI/ML training procedure has been activated by transmission of the training activation signal at 806, TRP 452 and UE 402 begin operating in low-reliability mode 802. In this example, the AI/ML training procedure is assumed to be an FL-based AI/ML training procedure in which TRP 452 and UE 402 iteratively exchange AI model updates. For example, in the first iteration indicated as Iteration 1 in FIG. 8, TRP 452 transmits AI model update information at 808₁, which may include global AI/ML model parameters as discussed previously. As discussed previously, in federated learning the transmission of the global AI model update information by TRP 452 at 808₁ may be a broadcast transmission that is broadcast to multiple UEs (including UE 402), whereas in distributed learning the transmission at 808₁ may be a unicast transmission specific to UE 402.

At 810₁, UE 402 initialize a local AI/ML model based on the AI model update information received at 808₁ (e.g., using the global AI/ML model parameters included in the AI model update information received at 808₁), and trains its local AI/ML model using its own data.

UE 402 may then transmit its own AI model update information at 812₁ to report updated local AI/ML model parameters to TRP 452.

At 814₁, TRP 452 may then aggregate the updated parameters reported from UE 402 and any other UE(s) that may be participating in the FL-based training procedure and update the global AI/ML model. The aforementioned procedure is one iteration of the FL-based AI/ML model training procedure, which in this example includes multiple iterations in low-reliability mode 802. For example, in the example depicted in FIG. 8, TRP 452 initiates a second iteration by transmitting updated AI model update information at 8082.

It is noted that in this example there is no HARQ feedback provided by UE 402 to TRP 452 and no retransmission of the downlink AI model update transmissions from TRP 452 to UE 402 in low-reliability mode 802. In addition, in low-reliability mode 802 low precision quantization may be used to express the value of parameters included in the AI model update information transmitted from TRP 452 to UE 402 (e.g., at 808ₓ) and/or in the AI model update information transmitted from UE 402 to TRP 452 (e.g., at 812ₓ), as discussed previously.

In this example TRP 452 and UE 402 perform N iterations of the FL-based AI/ML model training procedure in low-reliability mode 802. For example, similar to the first iteration (Iteration 1), in the Nth iteration indicated at Iteration N in FIG. 8, TRP 452 transmits AI model update information at 808_{N}. UE 402 updates its local AI/ML model at based on the AI model update information received at 808_{N} and trains its local AI/ML model using its own data at 810_{N}, and transmits its own AI model update information to TRP 452 at 812_{N}. At 814_{N}, TRP 452 may then aggregate the updated parameters reported from UE 402 and any other UE(s) that may be participating in the FL-based training procedure and update the global AI/ML model.

### Dynamic Switching Between Communication Modes

In FIG. 8, TRP 452 transmits switching signaling at 816 in order to dynamically switch between low-reliability mode 802 and high-reliability mode 804 during the AI/ML model training procedure. In some embodiments, TRP 452 could use DCI to dynamically switch between low-reliability mode 802 and high-reliability mode 804 at 816. In addition to mode switching, DCI could also indicate the quantization level in the switched-to mode, e.g. the number of bits used to express the value of a variable.

There are a number of possible ways in which DCI could be used to trigger a switch between reliability modes within an AI/ML model training procedure. For example, in some embodiments scheduling DCI may be used, whereas in other embodiments specific switching DCI may be used.

There are a number of ways in which existing scheduling DCI (i.e., DCI that is currently used for scheduling) could be used for reliability mode switching. For example, a “mode switching” field in the scheduling DCI may be used to indicate switching among modes. For example, to switch between 2 modes, 1 bit may be used, e.g. 0 indicates no switching, 1 indicates to switch from current mode to another mode (e.g., from low-reliability mode 802 to high-reliability mode 804 or vice versa). Alternatively, to switch from low-reliability mode 802 to high-reliability mode 804, because HARQ related fields (e.g., New data indicator, Redundancy version, HARQ process number, DAI, TPC for PUCCH, PUCCH resource indicator or HARQ timing fields) are not used in the low-reliability mode, one or more of the HARQ related field(s) in DCI could be used by TRP 452 to indicate dynamic switching from low-reliability mode 802 to high-reliability mode 804.

Similarly, there are a number of ways in which specific switching DCI (i.e., DCI that is not for scheduling, e.g., no resource allocation indication in the DCI) could be used for reliability mode switching. For example, UE-specific switching could be achieved using group common DCI (i.e., DCI that is common to a group of UE) that includes switching indications for multiple UEs in the group. For example, for a group of M UEs, the group common DCI may include M mode switching indications, e.g., mode switching indication 1, mode switching indication 2, . . . , mode switching indication M. For example, for UE 402, TRP 452 could configures the bit location of the mode switching indication for UE 402 in the group common DCI, so that UE 402 can decode its own mode switching indication. Alternatively, UE Group switching may be done by a broadcast indication, e.g. in federated learning, wherein one switching indication in the group common DCI is understood to be applicable to multiple UEs.

Iterations of the FL-based AI/ML model training procedure continue in high-reliability mode 804. In particular, as shown in FIG. 8, after switching from low-reliability mode 802 to high-reliability mode 804, TRP 452 initiates iteration N+1, which similar to the previous N iterations performed in low-reliability mode 802 includes AI model update transmission from TRP 452 to UE 402 at 808_{N+1}, training at UE 402 at 810_{N+1}, AI model update transmission from UE 402 to TRP 452 at 812_{N}+1 and training at TRP 452 at 814_{N+1}. However, in contrast to operation in low-reliability mode 802, in high-reliability mode 804, UE 402 reports HARQ feedback (indicated at 818ₓ in FIG. 8) in each iteration and TRP 452 may schedule retransmission when the HARQ feedback indicates that one or more portions of the transmitted data (e.g., one or more portions of the AI model update information transmitted at 808ₓ) has not been successfully decoded. For example, in Iteration N+1, UE 402 provides HARQ feedback 818_{N+1} that indicates UE 402 successfully decoded the AI model update information transmitted by TRP 452 at 808_{N+1}. However, in Iteration N+2, UE 402 does not successfully decode one or more portions of the AI model update information transmitted by TRP 452 at 808_{N+2} and, which UE 402 reports to TRP 452 by transmitting HARQ feedback at 818_{N+2,1}. In this example, based at least in part on the HARQ feedback from UE 402 at 818_{N+2,1}, TRP 452 schedules a retransmission of at least part of the AI model update information that was previously transmitted at 808_{N+2}. The retransmission is transmitted by TRP 452 at 820. In this example, it is assumed that UE 402 successfully decodes the AI model update information for Iteration N+2 after receiving the retransmission at 820, which UE 402 reports to TRP 452 by transmitting further HARQ feedback at 818_{N+2,2}. UE 402 then proceeds with training its local AI/ML model at 810_{N+2} and transmits AI model update information to TRP 452 at 812_{N+2}. As in the previous iterations, training of the global AI/ML model at TRP 452 proceeds at 814_{N+1}, after which TRP 452 may transmit further AI model update information at 808_{N+3} if further iterations are necessary. Details related to when and how an AI/ML model training procedure may be stopped are discussed later in this disclosure.

For the HARQ method utilized in high-reliability mode, rather than full ACK/NACK feedback in which both positive acknowledgements (ACKs) and negative acknowledgements (NACKs) are reported, ACK only feedback or NACK only feedback may be used in some embodiments. In an ACK only HARQ feedback scheme, HARQ feedback is only reported if the UE successfully decodes the data. If no ACK feedback is received, the data is assumed to have not been successfully decoded (e.g., if TRP 452 does not receive an ACK feedback from UE 402, TRP 452 may treat the lack of an ACK as a NACK). In contrast, in a NACK only HARQ feedback scheme, HARQ feedback is reported only if the UE fails to decode the data (e.g., if TRP 452 does not receive a NACK feedback from UE 402, TRP 452 may treat the lack of a NACK as an ACK).

As noted earlier, the reliability adaptation schemes disclose herein are applicable to DL, UL and sidelink transmissions. For example, the quantization precision level used in high-reliability mode 804 to express values of parameters in the AI model update information transmitted in the downlink direction from TRP 452 to UE 402 at 808ₓ and/or in the AI model update information transmitted in the uplink direction from UE 402 to TRP 452 at 812ₓ may be higher than the quantization precision level used in low-reliability mode 802 to express values of parameters in the corresponding uplink transmissions and/or downlink transmissions. However, for all reliability modes in UL, no HARQ feedback is sent for uplink transmission (e.g. no HARQ feedback for uplink transmission from UE 402 to TRP). For example, if TRP 452 fails to decode the AI model update information transmitted by UE at 812ₓ, TRP 452 may schedule a retransmission from UE 402 without transmitting HARQ feedback.

Dynamic switching between reliability modes, e.g., between low-reliability mode 802 and high-reliability mode 804, provides a tradeoff between overhead reductions and training performance. For example, avoiding retransmissions and/or utilizing lower precision quantization in low-reliability mode can reduce communication overhead during an early phase of training. However, once the outcome of training fails to meaningfully improve in low-reliability mode (e.g., if the validation loss improvement from one training iteration to the next falls below a certain threshold), TRP 452 can dynamically switch UE 402 to operate in high-reliability mode 804 in order to further improve the training performance.

### Dynamic Stop to Training for an Individual UE

TRP 452 may monitor the progress of the AI/ML model training procedure to determine whether the AI/ML model has converged sufficiently to satisfy one or more training goals/criteria, e.g., TRP 452 may check for convergence after each iteration of the AI/ML model training procedure. For example, as shown in FIG. 8, TRP 452 may transmit a training deactivation signal at 822 after P iterations in high-reliability mode 804 if TRP 452 determines that the AI/ML model has sufficiently converged at the conclusion of Iteration N+P. The training deactivation signal could be indicated by TRP 452 through RRC, MAC-CE, or DCI signaling, for example. For example, TRP 452 could send a DCI with a CRC that is scrambled by an RNTI that is specific to AI/ML training signaling, e.g., AI-training-RNTI, to deactivate the training procedure. For example, some specific fields in the DCI could be set as predefined values to indicate training deactivation, e.g. fields of Frequency/Time domain resource assignment, New data indicator, Redundancy version, HARQ process number, DAI, TPC for PUCCH, PUCCH resource indicator, or HARQ timing may be set to a predefined value (one example is given below in Table 2) that is understood to indicate that AI training is to be deactivated. In this scenario, in response to receiving the DCI scrambled by the specific RNTI in the deactivation signal at 822, UE 402 checks the value of those fields, and if the DCI is found to be deactivation DCI, then UE 402 stops the learning procedure.

TABLE 2

| Fields in DCI | De-activation DCI |
|---|---|
| Frequency/Time domain | Predefined value |
| resource assignment | |
| New data indicator | Predefined value |
| Redundancy version | Predefined value |
| HARQ process number | Predefined value |
| DAI, TPC for PUCCH, PUCCH | Predefined value |
| resource indicator, HARQ timing | |

In some embodiments, a network device, such as TRP 452, may indicate individual UEs to stop participating in a given training procedure, while continuing the training procedure with other UE(s). For example, a TRP that has initiated a federated learning-based or distributed learning-based training procedure with a group of UEs may, at some point in the training procedure, indicate that one or more of the participating UEs in the group should stop participating. In this scenario, the TRP and the remaining UEs in the group may continue to collaboratively train the AI model. If training of the AI model is successful, the trained model parameters may be shared with the UE(s) that were stopped from participating. A UE may be stopped from participating in training for various reasons. For example, the UE may be a laggard UE, e.g. experiencing poor channel quality, have poor AI capability, poor dynamic processing capability for AI training (e.g. the UE is in power saving mode or is implementing some complex signal processing algorithms). In such circumstances, involving the UE in the training procedure is likely to result in large air interface overhead due to the need for retransmissions and/or large delay for the AI model convergence. As such, in such circumstances the TRP could dynamically indicate a UE to stop the training procedure by RRC/MAC-CE/DCI signaling.

If a UE is not able to meaningfully contribute to the training procedure, being able to dynamically indicate the UE to stop training may have several benefits. For example, stopping a non-contributing UE from participating in training may reduce air interface overhead and/or training convergence may be achieved faster.

### UE-Assisted Dynamic Stop to Training

In some embodiments, a UE may provide assistance information to a network device to assist the network device in deciding whether to stop training at the UE. For example, in federated learning and distributed learning, the data is generally not identically distributed among UEs, i.e., the training data among different UEs is heterogeneous. In some embodiments, if UE 402 observes the correlation between its local AI/ML model and the global AI/ML model is getting worse during training, which may be caused by data heterogeneity, the UE 402 may report assistance information to TRP 452 to assist TRP 452 in making a stop training decision for UE 402. For example, the reported assistance information could include one or more of the following:
an explicit training stop request from the UE;
the UE's local model status, e.g. loss information of the local AI model.

After receiving the assistance information from the UE 402, TRP 452 could determine whether to stop training for the UE 402.

### UE-Assisted Dynamic Switching

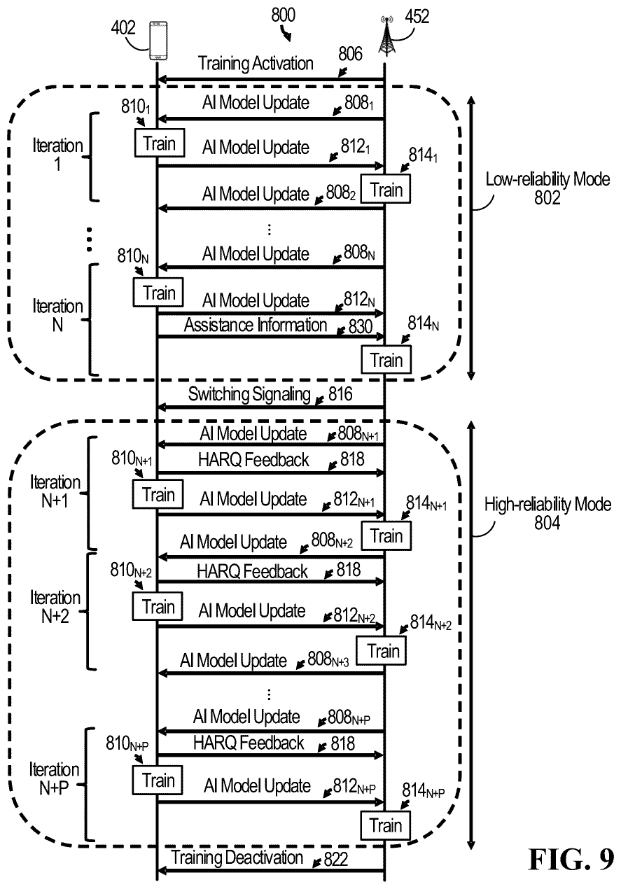

In addition to providing assistance information to assist TRP 452 in making a stop training decision for UE 402, when operating in a given mode UE 402 could also or instead report assistance information to assist TRP 452 in making a mode switching decision, e.g., to switch from low-reliability mode 802 to high-reliability mode 804. For example, FIG. 9 shows an example of the signal flow diagram 800 between UE 402 and TRP 452 that differs from the signal flow diagram 800 shown in FIG. 9 in that UE 402 transmits assistance information to TRP 452 at 830 during low-reliability mode 802. The assistance information transmitted at 830 could include one or more of:
an explicit mode switching request from the UE;
preferred quantization level request;
Details of AI model training performance: e.g. average local validation loss.

UE 402 may send such assistance information to TRP 452 periodically or aperiodically. There are a number of options for communication resources that could be used for the reporting of assistance information from UE 402 to TRP 452. For example, UE 402 could use the PUCCH resources indicated in scheduling DCI, or a dedicated PUCCH for assistance information reporting could be configured by TRP 452. Although the transmission of the assistance information at 830 is shown as taking place between the transmission of AI model update information 812_{N}, more generally UE 402 could potentially be configured to transmit assistance information at any time during operation in low-reliability mode 802. Furthermore, it is noted that in some embodiments, the assistance information that is shown as being transmitted at 830 in FIG. 9, could instead be transmitted within the same message as the AI model update information that is transmitted at 812_{N}.

### UE-Assisted Selective Retransmission

In reliability modes in which retransmissions are possible, e.g., in high-reliability mode 804, lost training data may be selectively retransmitted based on whether or not the lost data is considered to be important to training. For example, some lost data (e.g. global gradients in federated learning) may not be important to training at a UE. For example, a UE that fails to successfully decode AI model update information from a network device may be able to use other training data instead of the lost data (e.g. in a FL-based AI/ML model training procedure, a UE may be able to use the most recent local gradient for the next training iteration if there is high correlation between the global and local gradients). In such cases, the UE may be able to complete the next iteration of training without requiring retransmission of the lost data. Another scenario in which training may be able to productively proceed without requiring retransmission of lost data potentially arises when enough UEs participating in a FL-based AI/ML model training procedure successfully decode a global gradient transmission from the TRP even if some participating UEs fail to decode the global gradient transmission. For example, if at least Kᵢ UEs (Kᵢ is a threshold) fail to decode the global gradient transmission for a particular training iteration, then the TRP may consider it to be important and perform retransmission of the lost data. On the other hand, if fewer than Kᵢ UEs lost the data, then the TRP may avoid retransmission for that training iteration and may instead rely on the updated training data from other participating UE(s) that successfully decoded the global gradient transmission for that iteration. Therefore, even in high-reliability mode, a TRP may not retransmit some lost data.

To facilitate selective retransmission from a network device, a UE that has lost data may not only send HARQ-ACK feedback but may also send information indicating whether the lost data is important in order to assist the network device's retransmission decision. For example, the HARQ feedback transmitted by UE 402 at 818ₓ in FIGS. 8-10 may include Q bits for the HARQ-ACK feedback and Q bits for the importance of the data, where each bit is corresponding to one portion of the data (e.g. transport block or code block group or code block). For each portion of the data, when UE 402 reports ACK, TRP 452 can ignore the value of the corresponding importance bit (because the ACK report indicates the UE successfully decoded that portion of the data). However, if UE 402 reports NACK, TRP 452 decodes the value of the corresponding importance bit for the lost data, and determines whether to perform retransmission.

In some embodiments, if TRP 452 determines that retransmission will not be performed for a lost data of UE 402, then TRP 452 may inform UE 402 of the data which will not be retransmitted to UE 402, so that UE 402 can potentially use another training data for the AI model update in that iteration. In this way, the latency associated with waiting for retransmissions at the UE side can be reduced, because the UE can proceed with the AI model update using the other training data rather than waiting for retransmission of the lost data. For example, to inform UE 402 of the lost data that will not be retransmitted, TRP 452 could transmit DCI indicating the HARQ process(es) in which the transmission is ended. After receiving the indication, UE 402 could flush the HARQ buffer for the indicated HARQ process. The DCI used for this purpose could be UE-specific dedicated/scheduling DCI, or group common DCI, or broadcast DCI, for example.

### Semi-Static Switching Between Reliability Modes

In FIGS. 8 and 9, TRP 452 switches UE 402 between reliability modes dynamically via dynamic switching signaling at 816. In other embodiments, switching between reliability modes may be configured semi-statically. Taking switching from low-reliability mode 802 to high-reliability mode 804 as an example, a duration for low-reliability mode 802 may be semi-statically configured. For example, the semi-statically configured duration may be iteration step dependent or time dependent.

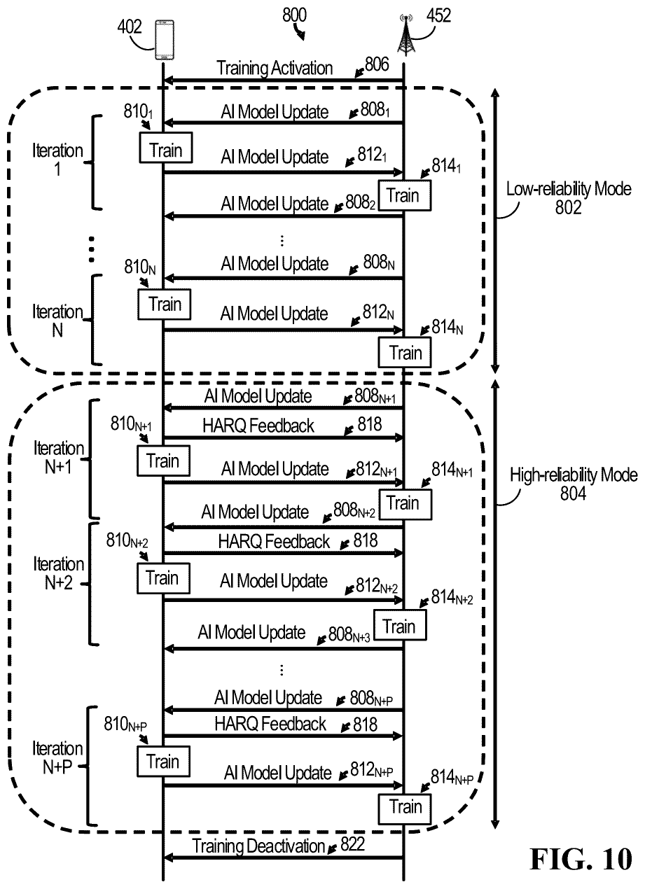

For example, UE 402 may be semi-statically configured to switch from low-reliability mode 802 to high-reliability mode 804 after N iteration steps, i.e. after receiving N DL transmissions for AI training model update after a reference time slot. For example, the reference time slot could be the beginning of the training procedure, e.g. the time at which UE 402 receives the training activation signal at 806. FIG. 10 depicts an example of such a scenario, in which UE 402 switches from low-reliability mode 802 to high-reliability mode 804 after Iteration N.

Alternatively, UE 402 may be semi-statically configured to switch from low-reliability mode 802 to high-reliability mode 804 after N subframes/slots/symbols, i.e. N subframes/slots/symbols after a reference time slot. For example, the reference time slot could be the beginning of the training procedure, e.g. the time at which UE 402 receives the training activation signal at 806.

In either case (iteration step dependent or time dependent), N could be predefined or configured by RRC/MAC-CE/DCI signaling, for example. The signaling used could be for UE-specific or UE group specific configuration. For example, if the training activation signal at 806 is indicated through DCI, the value for N may be indicated by as part of the same DCI used to indicate the training activation signal, e.g., by reusing one of the HARQ related field for the indication of N, such as one of the following fields: New data indicator, Redundancy version, HARQ process number, DAI, TPC for PUCCH, PUCCH resource indicator or HARQ timing.

If the duration of low-reliability mode 802 is semi-statically configured, the pre-configured duration may not be suitable in practice, so in some embodiments the duration of low-reliability mode 802 may be dynamically updated. For example, in the low-reliability mode 802, scheduling DCI could be used to indicate an updated duration for the low-reliability mode. For instance, the scheduling DCI may indicate a time length, e.g. M iterations steps or M subframes/slots/symbols. Then, from the time receiving the DCI, after the time length indicated by the DCI has elapsed (i.e., after M steps or M subframes/slots/symbols) the UE switches from the low-reliability mode 802 to the high-reliability mode 804.

For the scheduling DCI design, a specific field for “time length indicator” may be included in order to indicate the time length. Alternatively, the HARQ related fields which may not otherwise be used in low-reliability mode 802, e.g. fields of new data indicator, Redundancy version, HARQ process number, DAI, TPC for PUCCH, PUCCH resource indicator or HARQ timing, may be used to indicate the time length.

By performing the methods disclosed herein, the air interface resource overhead and delays associated with online AI/ML model training can be reduced while providing a tradeoff between overhead reductions and training performance.

Examples of devices (e.g. ED or UE and TRP or network device) to perform the various methods described herein are also disclosed.

For example, a first device may include a memory to store processor-executable instructions, and a processor to execute the processor-executable instructions. When the processor executes the processor-executable instructions, the processor may be caused to perform the method steps of one or more of the devices as described herein, e.g. in relation to FIGS. 8-10. As one example, the processor may communicate, in accordance with a reliability mode, AI/ML model training data with a second device, wherein the reliability mode is one of a plurality of reliability modes as described herein. For example, the processor may cause the device to communicate over an air interface in a mode of operation by implementing operations consistent with that mode of operation, e.g. performing necessary measurements and generating content from those measurements, as configured for the mode of operation, preparing uplink transmissions and processing downlink transmissions, e.g. encoding, decoding, etc., and configuring and/or instructing transmission/reception on RF chain(s) and antenna(s).

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

Although the present disclosure has been described with reference to specific features and embodiments thereof, various modifications and combinations can be made thereto without departing from the embodiments of the disclosure. The description and drawings are, accordingly, to be regarded simply as an illustration of some embodiments of the disclosure as defined by the appended claims, and are contemplated to cover any and all modifications, variations, combinations or equivalents that fall within the scope of the present disclosure. Therefore, although the present disclosure and its advantages have been described in detail, various changes, substitutions and alterations can be made herein without departing from the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

Moreover, any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

### DEFINITIONS OF ACRONYMS

LTE Long Term Evolution
NR New Radio
BWP Bandwidth part
BS Base Station
CA Carrier Aggregation
CC Component Carrier
CG Cell Group
CSI Channel state information
CSI-RS Channel state information Reference Signal
DC Dual Connectivity
DCI Downlink control information
DL Downlink
DL-SCH Downlink shared channel
EN-DC E-UTRA NR dual connectivity with MCG using E-UTRA and SCG using NR
gNB Next generation (or 5G) base station
HARQ-ACK Hybrid automatic repeat request acknowledgement
MCG Master cell group
MCS Modulation and coding scheme
MAC-CE Medium Access Control-Control Element
PBCH Physical broadcast channel
PCell Primary cell
PDCCH Physical downlink control channel
PDSCH Physical downlink shared channel
PRACH Physical Random Access Channel
PRG Physical resource block group
PSCell Primary SCG Cell
PSS Primary synchronization signal
PUCCH Physical uplink control channel
PUSCH Physical uplink shared channel
RACH Random access channel
RAPID Random access preamble identity
RB Resource block
RE Resource element
RRM Radio resource management
RMSI Remaining system information
RS Reference signal
RSRP Reference signal received power
RRC Radio Resource Control
SCG Secondary cell group
SFN System frame number
SL Sidelink
SCell Secondary Cell
SPS Semi-persistent scheduling
SR Scheduling request
SRI SRS resource indicator
SRS Sounding reference signal
SSS Secondary synchronization signal
SSB Synchronization Signal Block
SUL Supplement Uplink
TA Timing advance
TAG Timing advance group
TUE Target UE
UCI Uplink control information
UE User Equipment
UL Uplink
UL-SCH Uplink shared channel

1. A method, the method comprising:
at a first device in a wireless communication network:
communicating, in accordance with a first communication mode, data or control information with a second device in the wireless communication network, the first communication mode being one of a plurality of communication modes comprising at least the first communication mode and a second communication mode, the second communication mode differing from the first communication mode in terms of at least one of:
a quantization level used to quantize values of variables in the data or the control information; or
a Hybrid Automatic Repeat reQuest (HARQ) feedback and retransmission mode for selective retransmission of one or more portions of the data or the control information.

2. The method of claim 1, further comprising:
training an artificial intelligence or machine learning (AI/ML) model at the first device based on the data or the control information communicated with the second device.

3. The method of claim 1, wherein:
in the first communication mode, a first HARQ feedback and retransmission mode is used, wherein, in the first HARQ feedback and retransmission mode, there is no HARQ feedback process and no retransmission of the data or the control information between the first device and the second device; and
in the second communication mode, a second HARQ feedback and retransmission mode is used, wherein, in the second HARQ feedback and retransmission mode, there is a HARQ feedback process to request retransmission of the one or more portions of the data or the control information.

4. The method of claim 1, wherein:
in the first communication mode, a first HARQ feedback and retransmission mode is used, wherein N1 retransmissions are permitted in the first HARQ feedback and retransmission mode, wherein N1 is an integer and N1≥1; and
in the second communication mode, a second HARQ feedback and retransmission mode is used, wherein a maximum of N2 retransmissions are permitted in the second HARQ feedback and retransmission mode, wherein N2 is an integer and N2>N1.

5. The method of claim 3, wherein:
in the first communication mode, a first quantization level is used to quantize the values of variables in the data or the control information; and
in the second communication mode, a second quantization level, higher than the first quantization level, is used to quantize the values of variables in the data or the control information.

6. The method of claim 1, further comprising:
switching from communicating the data or the control information with the second device in accordance with the first communication mode to communicating data or control information with the second device in accordance with the second communication mode.

7. The method of claim 6, wherein switching comprises:
transmitting, from the first device, control signaling to the second device, the control signaling containing a switching instruction; and
after transmitting the control signaling, switching from the first communication mode to the second communication mode.

8. A device comprising:
at least one processor coupled with at least one memory storing processor-executable instructions that, when executed, cause the device to:
transmit, in accordance with a first communication mode, data or control information to another device in a wireless communication network, the first communication mode being one of a plurality of communication modes comprising at least the first communication mode and a second communication mode, the second communication mode differing from the first communication mode in terms of at least one of:
a quantization level used to quantize values of variables in the data or the control information; or
a Hybrid Automatic Repeat reQuest (HARQ) feedback and retransmission mode for selective retransmission of one or more portions of the data or the control information.

9. The device of claim 8, wherein the processor-executable instructions further comprise processor-executable instructions that, when executed, cause the device to:
train an artificial intelligence or machine learning (AI/ML) model at the device based on the data or control information communicated with the other device.

10. The device of claim 8, wherein:
in the first communication mode, a first HARQ feedback and retransmission mode is used, wherein, in the first HARQ feedback and retransmission mode, there is no HARQ feedback process and no retransmission of the data or the control information between the device and the other device; and
in the second communication mode, a second HARQ feedback and retransmission mode is used, wherein, in the second HARQ feedback and retransmission mode, there is a HARQ feedback process to request retransmission of the one or more portions of the data or the control information.

11. The device of claim 8, wherein:
in the first communication mode, a first HARQ feedback and retransmission mode is used, wherein N1 retransmissions are permitted in the first HARQ feedback and retransmission mode, wherein N1 is an integer and N1≥1; and
in the second communication mode, a second HARQ feedback and retransmission mode is used, wherein a maximum of N2 retransmissions are permitted in the second HARQ feedback and retransmission mode, wherein N2 is an integer and N2>N1.

12. The device of claim 10, wherein:
in the first communication mode, a first quantization level is used to quantize the values of variables in the data or the control information; and
in the second communication mode, a second quantization level, higher than the first quantization level, is used to quantize the values of variables in the data or the control information.

13. The device of claim 8, wherein the processor-executable instructions further comprise processor-executable instructions that, when executed, cause the processor device to:
switch from communicating data or control information with the other device in accordance with the first communication mode to communicating data or control information with the other device in accordance with the second communication mode.

14. The device of claim 13, wherein the processor-executable instructions that, when executed, cause the at least one processor to switch from the first communication mode to the second communication mode comprise processor-executable instructions that, when executed, cause the device to:
transmit, from the device, control signaling to the other device, the control signaling containing a switching instruction; and
after transmitting the control signaling, switch from the first communication mode to the second communication mode.

15. A non-transitory computer readable storage medium having instructions stored thereon, when the instructions executed by at least one computer, cause an apparatus in a wireless communication network to perform operations, wherein the operations comprise:
communicating, in accordance with a first communication mode, data or control information with another apparatus in the wireless communication network, the first communication mode being one of a plurality of communication modes comprising at least the first communication mode and a second communication mode, the second communication mode differing from the first communication mode in terms of at least one of:
a quantization level used to quantize values of variables in the data or the control information; or
a Hybrid Automatic Repeat reQuest (HARQ) feedback and retransmission mode for selective retransmission of one or more portions of the data or the control information.

16. The non-transitory computer readable storage medium of claim 15, the operations further comprising:
training an artificial intelligence or machine learning (AI/ML) model based on the data or the control information communicated with the another apparatus.

17. The non-transitory computer readable storage medium of claim 15, wherein:
in the first communication mode, a first HARQ feedback and retransmission mode is used, wherein, in the first HARQ feedback and retransmission mode, there is no HARQ feedback process and no retransmission of the data or the control information between the apparatus and the another apparatus; and
in the second communication mode, a second HARQ feedback and retransmission mode is used, wherein, in the second HARQ feedback and retransmission mode, there is a HARQ feedback process to request retransmission of the one or more portions of the data or the control information.

18. The non-transitory computer readable storage medium of claim 15, wherein:
in the first communication mode, a first HARQ feedback and retransmission mode is used, wherein N1 retransmissions are permitted in the first HARQ feedback and retransmission mode, wherein N1 is an integer and N1≥1; and
in the second communication mode, a second HARQ feedback and retransmission mode is used, wherein a maximum of N2 retransmissions are permitted in the second HARQ feedback and retransmission mode, wherein N2 is an integer and N2>N1.

19. The non-transitory computer readable storage medium of claim 17, wherein:
in the first communication mode, a first quantization level is used to quantize the values of variables in the data or the control information; and
in the second communication mode, a second quantization level, higher than the first quantization level, is used to quantize the values of variables in the data or the control information.

20. The non-transitory computer readable storage medium of claim 15, the operations further comprising:
switching from communicating data or control information with the another apparatus in accordance with the first communication mode to communicating data or control information with the another apparatus in accordance with the second communication mode.
